(19) United States
(12) Patent Application Publication
(10) Pub. No.: US 2024/0356144 A1
(43) Pub. Date: Oct. 24, 2024

(54) Method for Producing an Electric Energy Storage Device, Energy Storage Device, and Device

(71) Applicant: Bayerische Motoren Werke Akiengesellschaft, Muenchen (DE)

(72) Inventor: Christian GIROLSTEIN, Muenchen (DE)

(21) Appl. No.: 18/681,265

(22) PCT Filed: Sep. 5, 2022
(86) PCT No.: PCT/EP2022/074559

§ 371 Date: Feb. 5, 2024

(30) Foreign Application Priority Data
Sep. 20, 2021 (DE) 10 2021 124 229.0

(51) Int. Cl. H01M 50/264; H01G 2/02; H01G 13/00; H01M 50/213; H01M 50/244; H01M 50/291; H01M 50/293

(52) U.S. Cl. CPC H01M 50/264; H01G 2/02; H01G 13/00; H01M 50/213; H01M 50/244; H01M 50/291; H01M 50/293

(57) ABSTRACT

A method for producing an electric energy storage device comprising: providing a support structure for arranging at least one energy storage cell, wherein the support structure comprises an arranging surface for arranging at least one energy storage cell, and the support structure has at least one opening which extends transversely to the arranging surface; using the at least one opening in order to arrange an installation element which can be moved along a longitudinal axis of the opening; arranging an energy storage cell on the installation element, whereby a region of the energy storage cell is covered; and, arranging the energy storage cell on the arranging surface by moving the installation element and/or the support structure towards each other, wherein the aforementioned region of the energy storage cell is covered by the installation element until the energy storage cell is contacted by the arranging surface.

### BACKGROUND AND SUMMARY

The present disclosure relates to: a method for producing an electric energy store, an energy store, and an apparatus.

Energy stores of the type at issue comprise a multiplicity of energy storage cells which are interconnected to one another. A very wide variety of methods are used to fasten the energy storage cells and corresponding housings, on carriers, cooling elements, etc. Energy storage cells are often fastened via adhesive bonding, for example. This results in problems during manufacture in that it has to be ensured that certain regions of the energy storage cell such as, for example, those regions in which the degassing valves are arranged, remain free from adhesive.

It is therefore an object of the present disclosure to provide a method for producing an energy store, an energy store, and an apparatus, it being possible to ensure that certain regions of the energy storage cell are masked reliably when being fastened.

According to the disclosure, a method for producing an electric energy store comprises the steps: providing a supporting structure for the arrangement of at least one energy storage cell, the supporting structure comprising an arrangement surface for the arrangement of at least one energy storage cell, and the supporting structure having at least one opening which extends transversely with respect to the arrangement surface; using the at least one opening for the arrangement of a mounting element which can be moved along a longitudinal axis of the opening; arranging an energy storage cell on the mounting element, as a result of which a region of the energy storage cell is covered; and, arranging the energy storage cell on the arrangement surface via a movement of the mounting element and/or the supporting structure with respect to one another, the above-mentioned region of the energy storage cell being covered up to contact thereof with the arrangement surface via the mounting element.

The above-mentioned supporting structure is an element or component which serves for the arrangement preferably of a multiplicity of energy storage cells. In accordance with one preferred embodiment, the housings of the energy storage cells have a cylindrical shape. The energy storage cells are correspondingly preferably round cells. In accordance with one embodiment, the arrangement takes place by way of the bottom surface configured on the end side on the arrangement surface. A degassing valve is configured, for example, on the above-mentioned bottom surface. This valve expediently lies in the masking region and is therefore covered or shielded via the mounting element or its masking surface during the arrangement thereof.

The at least one opening can be configured during the production of the supporting structure or can be produced subsequently. The opening or recess can be formed through the structure of the supporting structure. A supporting structure which has a grid-shaped design has, for example, a multiplicity of angular recesses. The supporting structure preferably comprises a multiplicity of openings. The openings can serve to ventilate the supporting structure.

In accordance with one embodiment, as many mounting elements are provided as there are energy storage cells, with the result that all of the energy storage cells to be arranged can be arranged at once. As an alternative, the arrangement of the energy storage cells can also take place separately, or in sections, such as in rows.

In accordance with one embodiment, the shape of the mounting element or the shapes of the mounting elements is/are adapted to the shape or shapes of the openings in such a way that the mounting element or elements is/are guided, in particular during movement, in a positively locking manner. In particular, they are correspondingly adapted to one another. As viewed transversely with respect to the longitudinal axis of the openings/openings, the mounting element or elements can also be of smaller configuration than this opening/these openings. As an alternative, furthermore, a plurality of mounting elements can also be arranged in one opening, in particular if the opening is, for example, of slot-shaped configuration.

The method expediently comprises the step of applying adhesive to a contact surface of the energy storage cell and/or to the arrangement surface.

The contact surface of the energy storage cell is that surface which serves for the arrangement and fastening of the energy storage cell on the arrangement surface. The adhesive can be applied on the contact surface and/or the arrangement surface. The adhesive is typically displaced laterally when the contact surface and the arrangement surface come into contact with one another, which can lead to adhesive penetrating into regions which must not be wetted with adhesive. In the present case, this effect is advantageously prevented via the mounting elements which, at the time of the contact of the contact surface with the arrangement surface, cover the energy storage cell at least in regions. The mounting elements advantageously act as an “adhesive barrier”.

In accordance with one preferred embodiment, the method comprises the step of applying adhesive around the edge of the at least one opening.

This entails the advantage that regions of the energy storage cell are not accidentally wetted with adhesive as early as the application of the adhesive. Accordingly, the application of adhesive takes place exclusively on to the arrangement surface or, for example, around the edge of the at least one opening, or around the edge of the openings.

In accordance with one embodiment, the mounting element comprises a multiplicity of masking surfaces. This is to be understood to mean that, for example, the mounting element is correspondingly shaped or structured on the end side, such that a plurality of regions of the energy storage cell which are spaced apart from one another or are different can be covered or shielded. In accordance with one embodiment, the masking surfaces lie perpendicularly with respect to the longitudinal axis. As an alternative, at least one marking surface is oriented in an inclined manner or in parallel with respect to the longitudinal axis.

It is to be mentioned here that the shape of the housings of the energy storage cells is not restricted to the above-mentioned round cell shape. As an alternative, the energy storage cells are, for example, energy storage cells with prismatic housings.

In accordance with one embodiment, the method comprises the steps: providing a load-bearing structure, comprising a multiplicity of mounting elements; arranging the supporting structure on the load-bearing structure; and, arranging energy storage cells on the mounting elements which protrude beyond the arrangement surface.

One energy storage cell is expediently provided per mounting element. As an alternative, a plurality of energy storage cells can also be arranged on one mounting element, depending on the geometry of the corresponding opening.

In accordance with one preferred embodiment, the supporting structure has a multiplicity of openings or recesses, with a round or angular cross section, for example, one round cell being arranged in each case in an extension of each opening or recess. The abovementioned recesses or openings expediently serve for aeration/ventilation of the energy storage cell. The arrangement of the energy storage cells or round cells expediently takes place around the edge of the respective opening.

In accordance with one embodiment, the method comprises the step of moving the load-bearing structure and/or the supporting structure during the arrangement of the energy storage cells on the arrangement surface.

After the arrangement of the supporting structure on the load-bearing structure, the load-bearing structure can either be moved in such a way that the energy storage cells are arranged on the arrangement surface. As an alternative, the supporting structure can be moved toward the energy storage cells. Furthermore, as an alternative, both the supporting structure and the load-bearing structure can be moved correspondingly.

In accordance with one embodiment, the method comprises the step of moving the mounting element or the mounting elements via the arrangement of the energy storage cells.

The mounting elements and/or also the entire load-bearing structure can be moved, for example, via the arrangement of the energy storage cells. In accordance with one embodiment, the mounting elements, or the at least one mounting element, or the load-bearing structure are/is mounted in a sprung manner. The energy storage cells are moved onto the arrangement surface counter to the spring force. The energy storage cells are therefore loaded with force which is expediently maintained until the energy storage cells are completely fastened and/or the load-bearing structure or the mounting elements is/are removed. The spring preloading of the mounting element or the mounting elements can ensure that reliable contact of the mounting elements or their masking regions is maintained during the entire arrangement process of the energy storage cells.

In accordance with one embodiment, the masking surfaces of the mounting elements are provided with a structure and/or coating which makes improved adhesion of the energy storage cells possible. In this way, it can be ensured that the energy storage cells are held securely during the arrangement.

The method expediently comprises the step of removing the at least one mounting element from or out of the supporting structure after the arrangement of the at least one energy storage cell.

The mounting element or the mounting elements is/are expediently removed from the supporting structure.

After the joining process, the mounting elements are pulled out of the component, the supporting structure, as a result of which, in the case of previous contact with adhesive, this adhesive is automatically wiped off, depending on the geometry of the opening or recess. Any adhesive remaining in the supporting structure is unproblematic.

The use of the mounting elements advantageously makes a variable joining apparatus possible which prevents a flow of the adhesive into functional regions of the energy storage cell (in particular, a degassing valve).

The disclosure also relates to an energy store, comprising a multiplicity of energy storage cells, the multiplicity of energy storage cells being arranged, in particular fastened, on the supporting structure. The fastening takes place, in particular, in an integrally joined manner, in particular via adhesive.

In accordance with one preferred embodiment, the supporting structure is manufactured from plastic, in particular from a foamed plastic. The abovementioned openings and recesses expediently extend transversely with respect to an arrangement surface of the supporting structure. Transversely and/or obliquely with respect to the arrangement surface, the supporting structure can likewise have channels or the like, in particular for the connection of the openings or recesses among one another.

The energy store expediently comprises a housing, to which the supporting structure is fastened in a positively locking and/or non-positive and/or integrally joined manner. In accordance with one preferred embodiment, the housing comprises a housing upper part and a housing lower part. The supporting structure is preferably fastened to the housing lower part, for example, via adhesive. Typical housing materials comprise metallic materials and also non-metallic materials or a combination of the abovementioned materials. The supporting structure made from a foamed plastic, as mentioned above, is also distinguished, in particular, by a highly satisfactory crash behavior and a low weight.

Furthermore, the disclosure relates to an apparatus for carrying out the method according to the disclosure, the apparatus comprising a load-bearing structure which has at least one mounting element which extends along a longitudinal axis and, on the end side, has a masking surface which is designed and shaped to cover a region or portion of an energy storage cell.

It is to be mentioned at this point that the advantages and features mentioned in conjunction with the method apply analogously or correspondingly to the apparatus and the energy store, and vice versa.

In accordance with one embodiment, the masking surface has a structure and/or coating. This is provided and designed to make secure arrangement of one or more energy storage cells possible. In particular, reliable sealing of the masking region or the masking regions is also intended to be made possible. To this end, the structure and/or coating have/has, for example, a slightly flexible or soft surface, such as a rubberized surface.

In accordance with one embodiment, the mounting element has the shape of the masking surface along its longitudinal axis. In accordance with one embodiment, the mounting element is of cylindrical configuration. The cylindrical shape is expediently adapted to the opening or recess of the supporting structure in such a way that the mounting element expediently bears in a positively locking manner along its entire length within the opening during the movement.

As has already been mentioned, an opening can also be configured in such a way that a plurality of mounting elements can be arranged. An opening of this type can be, for example, of substantially slot-shaped configuration. The edges of the openings or recesses expediently form the arrangement surface or the arrangement surfaces for the energy storage cells.

In accordance with one embodiment, the mounting element comprises a web element which, on the end side, has a cup-shaped element, on which the masking surface is configured. In the case of this embodiment, the mounting element is not guided within the opening or through the latter. The above-mentioned web element is, for example, considerably thinner than the corresponding opening. The above-mentioned cup-shaped element can have, for example, the shape of the respective opening in cross section or else not.

### BRIEF DESCRIPTION OF THE DRAWINGS

Further advantages and features result from the following description of one embodiment of the method and an energy store and an apparatus, with reference to the appended figures, in which:

FIG. 1a shows a diagrammatic view of one embodiment of an energy storage cell,

FIG. 1b shows a diagrammatic view of an apparatus or a drawing for illustrating a method step,

FIG. 2 shows the arrangement known from FIG. 1b in the case of contact of the energy storage cells with the supporting structure,

FIG. 3a shows the arrangement known from FIGS. 1b and 2, the load-bearing structure being pulled out of the supporting structure,

FIG. 3b shows the arrangement known from FIGS. 1b to 3a after the removal of the load-bearing structure, and

FIG. 4 shows a plan view of one embodiment of the supporting structure.

### DETAILED DESCRIPTION OF THE DRAWINGS

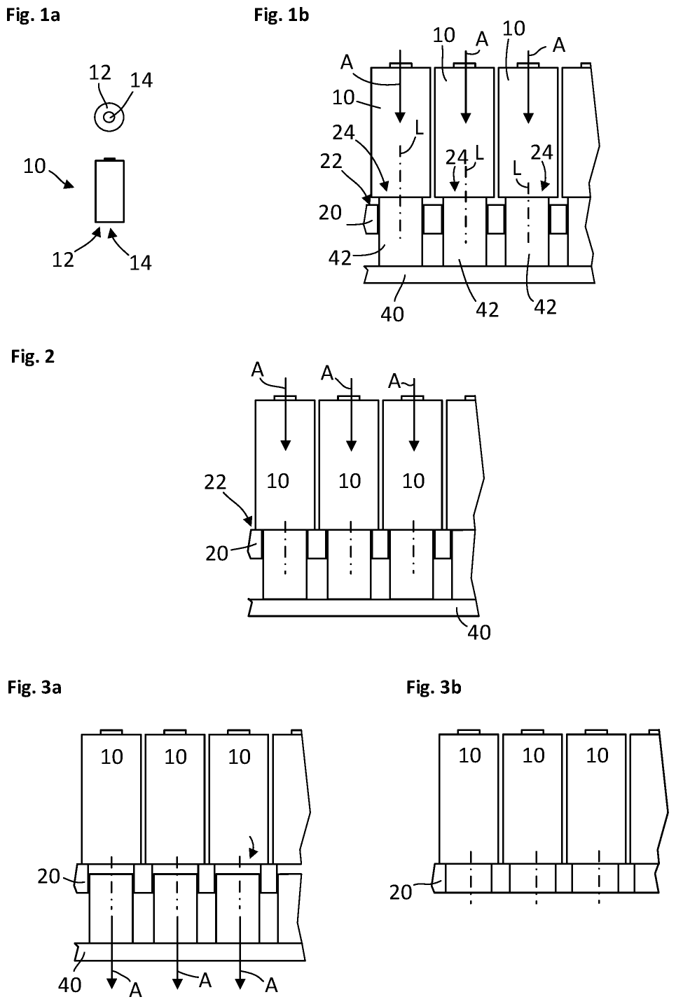

FIG. 1a shows a diagrammatic view of one embodiment of an energy storage cell 10 which is configured as a round cell in the present case. The energy storage cell 10 has a cylindrical main body which has a contact surface 12 on its lower side. A degassing valve which cannot be seen in the present case is arranged in the region of or on the contact surface 12. This degassing valve is intended to not be wetted with adhesive, for example, during the fastening of the energy storage cell 10 indirectly via the lower side. The region which is not to be wetted with adhesive is also called a “masking region” 14 in the present case. The energy storage cell can be seen from below in the upper image half, with the result that the position of the masking region 14 relative to or within the contact surface 12 per se can be seen. A multiplicity or plurality of energy storage cells 10 of this type are arranged in energy stores, for example, up right, next to one another. Here, for example, cooling elements run between the energy storage cells 10; in addition, or as an alternative, however, cooling can also be carried out from different sides.

FIG. 1b shows a diagrammatic view of a supporting structure 20 which has an arrangement surface 22. A multiplicity of energy storage cells 10, as known from FIG. 1a, are to be arranged and, in particular, fastened, preferably via adhesive, on the arrangement surface 22. Substantially transversely with respect to the arrangement surface 22, the supporting structure has a multiplicity of openings or recesses 24. In each case one energy storage cell 10 is arranged in each case in an extension of these openings or recesses 24. Therefore, the degassing valves lie in each case in the region of the openings 24, with the result that degassing is advantageously possible in the case of damage. The recesses/openings 24 and the energy storage cells 10 extend along the longitudinal axes L. The arrangement of the energy storage cells 10 also takes place along these longitudinal axes L, that is, the arrangement direction A which is outlined via corresponding arrows. The arrangement of the energy storage cells 10 then advantageously takes place indirectly via the mounting elements 42 of the load-bearing structure 40. The energy storage cells 10 advantageously bear on the end side against the mounting element 42, as a result of which the central region of the energy storage cells 10 (that is, the masking regions 14) is covered. It can be seen that, in the state which is shown in FIG. 1b, the mounting elements 42 still protrude on the end side beyond the arrangement surface 22. At this time, adhesive has expediently already been applied on the arrangement surface 22 and/or on the lower side of the energy storage cells 10 (not shown here). The energy storage cells 10 are then moved along the arrangement direction A in the direction of the arrangement surface 22, these energy storage cells 10 making contact with the mounting elements 42 and being masked in regions in the process.

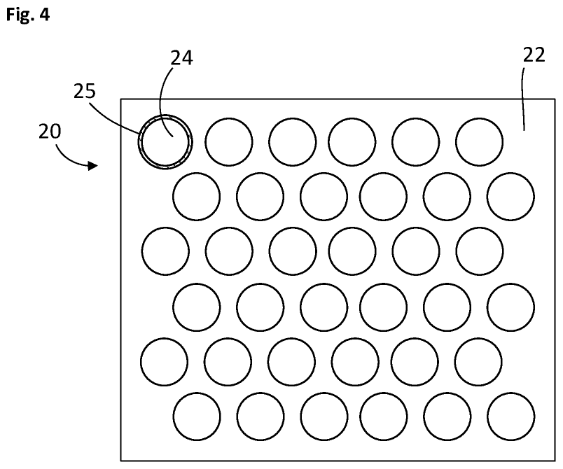

FIG. 2 shows substantially the arrangement known from FIG. 1b, the energy storage cells 10 making contact with the arrangement surface 22 of the supporting structure 20. A lateral displacement of the applied adhesive takes place precisely in the state. Since the energy storage cells 10 are covered in regions via the mounting elements 42, the masking regions 14 (see also Fig. la in this regard) remain free from adhesive. The load-bearing structure 40 is then pulled further out of the supporting structure along the arrangement direction A, or is moved via the energy storage cells 10 (see FIGS. 3a and 3b in this regard).

During pulling out or generally “moving” of the mounting elements 42 or the load-bearing structure 40 from the supporting structure 20 (see FIG. 3a, for example), it can occur that adhesive which adheres to the mounting elements 42 is stripped off laterally within the openings 24. This is unproblematic, however.

FIG. 3b shows the state in which the energy storage cells 10 are arranged completely on the supporting structure 20. The supporting structure 20 is manufactured, for example, from a plastic. In accordance with one preferred embodiment, for example, a foamed plastic is used to form the supporting structure 20. This material is very light and can absorb a large amount of energy in the case of a crash. An arrangement as can be seen in FIG. 3b, comprising a multiplicity of energy storage cells, arranged on a supporting structure, is arranged or fastened, for example, on a housing lower part of an energy store. The fastening of the supporting structure to the housing lower part can take place via adhesive, for example. As a result of this arrangement, the structure of the housing lower part is reinforced indirectly via the supporting structure 20. In order to close the housing, a corresponding housing upper part is provided which is oriented in the direction of the passenger compartment if the energy storage cell is used in a passenger motor car. It is to be mentioned at this point that the energy stores of the type at issue are expediently used in the present case for land vehicles, such as for passenger motor cars, motorcycles and/or also utility vehicles.

FIG. 4 shows a plan view of a supporting structure 20; an arrangement surface 22 and a multiplicity of openings or recesses 24 can be seen. These are of round, in particular circular, configuration in the present case, the shape not being restricted to this embodiment. It is shown by way of example in the left-hand upper corner that adhesive 25 is applied around an opening 24. The fastening of an energy storage cell (not shown here) takes place by way of this annular surface. In the same way, adhesive can be applied around the other openings 24. As an alternative, the entire arrangement surface 22 can also be wetted with adhesive, since the energy storage cells are advantageously masked via the mounting elements.

### List of Designations

10 Energy storage cell
12 Contact surface
14 Masking region
20 Supporting structure
22 Arrangement surface
24 Opening, recess
25 Adhesive
40 Load-bearing structure
42 Mounting element
A Arrangement direction
L Longitudinal axis

1.-15. (canceled)

16. A method for producing an electric energy store, comprising:
providing a supporting structure for the arrangement of at least one energy storage cell, the supporting structure comprising an arrangement surface for the arrangement of at least one energy storage cell, and at least one opening which extends transversely with respect to the arrangement surface;
using the at least one opening for the arrangement of the mounting element which can be moved along a longitudinal axis of the opening;
arranging an energy storage cell on the mounting element, as a result of which a region of the energy storage cell is covered; and,
arranging the energy storage cell on the arrangement surface via a movement of the mounting element and/or the supporting structure with respect to one another, the region of the energy storage cell being covered up to contact thereof with the arrangement surface via the mounting element.

17. The method according to claim 16, comprising:
applying adhesive to a contact surface of the energy storage cell and/or to the arrangement surface.

18. The method according to claim 16, comprising:
applying adhesive around the edge of the at least one opening.

19. The method according to claim 16, wherein:
the mounting element comprises a multiplicity of masking surfaces.

20. The method according to claim 16, comprising:
providing a load-bearing structure, comprising a multiplicity of mounting elements;
arranging the supporting structure on the load-bearing structure; and,
arranging energy storage cells on the mounting elements which protrude beyond the arrangement surface.

21. The method according to claim 20, comprising:
moving the load-bearing structure and/or the supporting structure for the arrangement of the energy storage cells on the arrangement surface.

22. The method according to claim 16, comprising:
moving the mounting structures via the arrangement of the energy storage cells.

23. The method according to claim 16, comprising:
removing the at least one mounting element from or out of the supporting structure after the arrangement of the at least one energy storage cell.

24. An energy store, comprising a multiplicity of energy storage cells, produced in accordance with the method of claim 16, wherein:
the multiplicity of energy storage cells is arranged and fastened on the supporting structure.

25. The energy store according to claim 24, wherein:
the supporting structure comprises a foamed plastic.

26. The energy store according to claim 24, comprising:
a housing, to which the supporting structure is fastened in a positively locking and/or non-positive and/or integrally joined manner.

27. An apparatus for carrying out a method according to claims 16, comprising:
a load-bearing structure which has at least one mounting element which extends along the longitudinal axis and, on the end side, has a masking surface which is designed and shaped to cover a region or portion of an energy storage cell.

28. The apparatus according to claim 27, wherein:
the masking surface includes a structure and/or coating.

29. The apparatus according to claim 27, wherein:
the mounting element has the shape of the masking surface along the longitudinal axis.

30. The apparatus according to claim 27, wherein:
the mounting element comprises a web element which, on the end side, has a cup-shaped element, on which the masking surface is configured.
